(19) United States
(12) Patent Application Publication
(10) Pub. No.: US 2026/0034748 A1
(43) Pub. Date: Feb. 5, 2026

(54) FIBRE REINFORCED COMPOSITE METHOD

(71) Applicant: BAE Systems plc, London (GB)

(72) Inventors: Gregory Elliot Nash, Samlesbury Lancashire (GB); Christopher Dighton, Filton Bristol (GB)

(73) Assignee: BAE Systems plc, London (GB)

(21) Appl. No.: 18/994,820

(22) PCT Filed: Jul. 28, 2023
(86) PCT No.: PCT/GB2023/052006

§ 371 Date: Jan. 15, 2025

(30) Foreign Application Priority Data
Aug. 5, 2022 (GB) 2211579.4

(51) Int. Cl. B29C 70/08; B29C 70/34; B29C 70/38; B29C 70/88; B29K 305/00; B29K 307/04; B29L 7/00

(52) U.S. Cl. CPC B29C 70/088; B29C 70/34; B29C 70/386; B29C 70/882; B29K 2305/00; B29K 2307/04; B29K 2995/0005; B29K 2995/0007; B29L 2007/007

(57) ABSTRACT

A method of providing a pre-impregnated tape (15), comprising reinforcement fibres (11), for manufacture of fibre-reinforced composite parts, the method comprising: non-uniformly impregnating (14) an additive composition in and/or on a tape (13), comprising reinforcement fibres, to provide the pre-impregnated tape, wherein the additive composition comprises a resin and an additive.

### FIELD

This invention relates to tapes, comprising reinforcement fibres, for manufacture of fibre-reinforced composite parts, particularly to pre-impregnated tapes, comprising reinforcement fibres, for manufacture of fibre-reinforced composite parts.

### BACKGROUND

Automated layup for fibre-reinforced composites, for example by automated tape laying (ATL) and automated fibre placement (AFP), typically involves laying fibre tapes, fabrics or tows onto moulds, using robots or CNC machines, for example. The tapes, fabrics and tows may be binder infused or resin impregnated (also known as pre-pregs). Layup for fibre-reinforced composite parts may be accelerated by laying multiple courses concurrently, laying multiple tapes or tows simultaneously and/or by increasing the width of the tapes, fabrics or tows. ATL typically uses tapes (also known as fabrics or cloths) having relatively wider widths of 2, 3, 6, 12 or 24 inch (nominally 51, 76, 152, 305, or 610 mm) while AFP typically uses tows (also known as ribbons) having relatively narrower widths of ⅛ ¼, ½ or 1 inch (3.17, 6.35, 12.7 or 25.4 mm), though there is the drive to further increase the width of tows to 1.5 inches (38.1 mm). The selection of widths of the tapes, fabrics or tows is typically limited by part curvature in two or three dimensions.

Functional tapes (including functionally-graded tapes) may be used to transition between two different fibre-reinforced composite parts having different properties, for example having different dielectric properties. Typically, functional tapes comprise functional additives, such as electrically and/or thermally conductive particles, magnetic particles and/or structural particles, included in the resin of a pre-impregnated tape, and/or one or more functional layers on a tape, such as a pre-impregnated tape, thereby changing the properties, such as electrical, thermal, magnetic and/or structural properties, of the tape. By grading (also known as graduating or tapering) the functional additives and/or functional layers, the properties may be varied across a width and/or along a length of the functional tapes. In a specific example, a taper in electrical conductivity may be required to enable a dielectric component (for example, a radome) to be integrated with a carbon fibre structural component of an airframe.

Conventional methods of providing functional tapes, comprising reinforcement fibres, for manufacture of fibre-reinforced composite parts are relatively complex, costly and/or energy intensive. For example, conventional methods of providing tapes having resistive tapers rely on sputtering of conductive particles onto a pre-impregnated tape that is then integrated into a ply layup.

Hence, there is a need to improve the manufacture of tapes, comprising reinforcement fibres, for manufacture of fibre-reinforced composite parts.

### SUMMARY

A first aspect provides a method of providing a pre-impregnated tape for manufacture of fibre-reinforced composite parts, the method comprising: non-uniformly impregnating an additive composition in and/or on a tape to provide the pre-impregnated tape, wherein the additive composition comprises a resin and an additive and wherein the tape comprises reinforcement fibres.

In this way, the pre-impregnated tape may be used to transition between fibre-reinforced composite parts having different properties, for example having different dielectric properties. For example, a taper in electrical conductivity is required to enable a dielectric component (for example, a radome) to be integrated with a carbon fibre structural component of an airframe. Other applications include EMI/RFI shielding, lightning strike protection, tailored functionality. In contrast with conventional methods of providing tapes, comprising reinforcement fibres, for manufacture of fibre-reinforced composite parts, the method according to the first aspect is relatively simple, inexpensive and/or not energy intensive since the additives are deposited in and/or on the tape by impregnating the additive composition in and/or on the tape, to provide the pre-impregnated tape. Particularly, the method according to the first aspect allows for a resistive taper in one singular ply, thus reducing the complexity and features required at various points in the fibre-reinforced composite parts (e.g. a composite aircraft part, such as an airframe). For example, by non-uniformly depositing the additive in and/or on the tape during impregnation thereof, such as by graduating deposition, patterning and/or masking of the additive, heterogeneous deposition of the additive is provided, thereby providing a tape having graded or patterned properties, such as electrical, thermal, magnetic and/or structural properties, of the pre-impregnated tape. In other words, such properties of the pre-impregnated tape are tailored or customised, such as to a taper in electrical conductivity to enable a dielectric component (for example, a radome) to be integrated with a carbon fibre structural component of an airframe. For example, the method according to the first aspect allows variable properties, e.g. conductivity, across a single reel of material while the method may be altered in-line, allowing bespoke reels to be produced.

The tape may be provided as a tape of woven and/or braided continuous fibres or provided by spreading one or more tows, for example.

In one example, the tape comprises aligned and/or continuous reinforcement fibres, for example woven and/or braided continuous fibres. In one example, the tape is dry (i.e. does not comprise resin impregnated therein and hence is not pre-impregnated) before non-uniformly impregnating the additive composition in and/or on the tape, comprising the reinforcement fibres, to provide the pre-impregnated tape. In one example, the tape is at least partly pre-impregnated (i.e. does comprise at least some resin impregnated therein) before non-uniformly impregnating the additive composition in and/or on the tape, comprising the reinforcement fibres, to provide the pre-impregnated tape.

In one example, the method comprises spreading one or more tows (i.e. untwisted bundles of continuous reinforcement fibres, for example provided on spools), comprising the reinforcement fibres, thereby providing the tape.

It should be understood that the tape is permeable or semi-permeable with respect to the resin but at most semi-permeable with respect to the additive, thereby depositing at least some of the additive therein and/or thereon, for example on the reinforcement fibres and/or in pores therebetween.

In one example, the additive comprises and/or is a functional additive (i.e. having required electrical, thermal, magnetic and/or structural properties to provide desired respective properties of the pre-impregnated tape for the fibre-reinforced composite parts). In one example, the additive comprises and/or is particles. In one example, the additive comprise and/or are electrically conductive particles, for example metal particles such as Au, Ag, Ni, Cu, Al and/or non-metal particles such as graphene, reduced graphene oxide, conductive oxides. In one example, the additive comprise and/or are nanoparticles, microparticles, nanowires, nanosheets, flakes.

In one example, the metal is a transition metal, for example a first row, a second row or a third row transition metal. In one example, the metal is Sc, Ti, V, Cr, Mn, Fe, Co, Ni, Cu or Zn. In one example, the metal is Y, Zr, Nb, Mo, Tc, Ru, Rh, Pd, Ag or Cd. In one example, the metal is Hf, Ta, W, Re, Os, Ir, Pt, Au or Hg. In one example, the metal is a lanthanide. In one example, the metal is La, Ce, Pr, Nd, Pm, Sm, Eu, Gd, Tb, Dy, Ho, Er, Tm, Yb or Lu. In one example, the metal is an actinide. In one example, the metal is Ac, Th, Pa, U, Np, Pu, Am, Cm, Bk, Cf or Es.

In one example, the additive comprises a metal, for example a pure or unalloyed metal or an alloy thereof, for example any metal amenable to fusion by melting. In one example, the additive comprise a metal, for example a pure metal or an alloy, for example any metal from particles, for example powder particles, such as produced by atomisation.

These powder particles may be produced by atomisation, such as gas atomisation or water atomisation, or other processes known in the art.

In one example, the additive comprises an inorganic compound. Inorganic compounds such as ceramics comprising the functional metal may include, for example, oxides, silicates, sulphides, sulphates, halides, carbonates, phosphates, nitrides, borides, hydroxides of the metal. These inorganic compounds may include a second such metal, for example, mixed oxides such as a mixture of barium titanate and strontium titanate such as (Ba, Sr)TiO₃. The additive may comprise TCP (tricalciumphosphate), MCP (monocalciumphosphate), DCP (dicalciumphosphate), tetracalciumphosphate, hydroxylapatite, alpha-TCP, beta-TCP, titanium oxide (fitania), aluminium oxide (alumina), zirconium oxide (zirconia), yttrium oxide (yttria), yttria stabilized zirconia, indium oxide, indium tin oxide, boron nitride, silicon carbide, boron carbide, tungsten carbide, beryllium oxide, zeolite, cerium oxide (ceria), tungsten disilicide, sodium silicide, platinium silicide, zirconium nitride, tungsten nitride, vanadium nitride, tantalum nitride, niobium nitride, silicon boride, barium titanate, lead zirconate titanate, zinc oxide, potassium niobate, lithium niobate, sodium tungstate, sodium chloride, sodium nitrate, potassium nitrate, potassium chloride, magnesium chloride, calcium chloride, calcium nitrate, magnesium nitrate, strontium oxide, strontium phosphate, strontium titanate, calcium sulfate, barium sulfate, calcium carbonate, sodium carbonate and/or sodium fluoride or mixtures thereof.

Preferably, the additive comprise a transition metal and/or an oxide thereof.

The additive particles may have regular, such as spherical, cuboidal or rod, shapes and/or irregular, such as spheroidal, flake or granular, shapes (also known as morphologies).

The inventors have identified that a size, for example the diameter, of the additive particles (or a largest dimension of an agglomerate) may affect dispersion thereof in the additive composition and/or in and/or on the pre-impregnated tape. Non-uniform dispersion in the additive composition may result in undesired inhomogeneity in the pre-impregnated tape. Such undesired inhomogeneity in the pre-impregnated tape may be unsuitable for the pre-impregnated tape. Relatively small particles may adversely affect viscosity. Relatively large particles may result in blockages.

At least 50% by weight of the additive particles may have a diameter of at most 100 nm. For regular shapes, the diameter may refer to the diameter of a sphere or a rod, for example, or to the side of a cuboid. The diameter may also refer to the length of the rod. For irregular shapes, the diameter may refer to a largest dimension, for example, of the particles. Suitably, the particle size distribution is measured by use of light scattering measurement of the particles in an apparatus such as a Malvern Mastersizer 3000, arranged to measure particle sizes from 10 nm to 3500 micrometres, with the particles wet-dispersed in a suitable carrier liquid (along with a suitable dispersant compatible with the particle surface chemistry and the chemical nature of the liquid) in accordance with the equipment manufacturer's instructions and assuming that the particles are of uniform density.

In one example, the additive particles comprise and/or are nanoparticles, having a diameter in a range from 1 nm to 100 nm, preferably in a range from 10 nm to 90 nm, more preferably in a range from 15 nm to 85 nm, most preferably in a range from 25 nm to 75 nm, for example 50 nm. In one example, the additive particles comprises and/or are nanoparticles, wherein at least 50% by weight of the nanoparticles have a diameter in a range from 1 nm to 100 nm, preferably in a range from 10 nm to 90 nm, more preferably in a range from 15 nm to 85 nm, most preferably in a range from 25 nm to 75 nm, for example 50 nm. In one example, the additive particles comprise and/or are nanoparticles, wherein at least 90% by weight of the nanoparticles have a diameter in a range from 1 nm to 100 nm, preferably in a range from 10 nm to 90 nm, more preferably in a range from 15 nm to 85 nm, most preferably in a range from 25 nm to 75 nm, for example 50 nm. In one example, the additive particles comprise and/or are nanoparticles, wherein at least 95% by weight of the nanoparticles have a diameter in a range from 1 nm to 100 nm, preferably in a range from 10 nm to 90 nm, more preferably in a range from 15 nm to 85 nm, most preferably in a range from 25 nm to 75 nm, for example 50 nm. In one example, the additive particles comprises and/or are nanoparticles, wherein at least 99% by weight of the nanoparticles have a diameter in a range from 1 nm to 100 nm, preferably in a range from 10 nm to 90 nm, more preferably in a range from 15 nm to 85 nm, most preferably in a range from 25 nm to 75 nm, for example 50 nm.

Particles of these sizes may be termed nanoparticles. Generally, nanoparticles tend to agglomerate, to reduce surface energy. Agglomerates are an assembly of a variable number of the particles and the agglomerates may change in the number of particles and/or shape, for example. Nanopowders are solid powders of nanoparticles, often containing micron-sized nanoparticle agglomerates. These agglomerates may be redispersed (at least to some extent) in the solid state using, for example, ultrasonic processing. Nanoparticle dispersions are suspensions of nanoparticles in a liquid carrier, for example water or organic solvent/organic matrix. Agglomeration may depend, for example, on temperature, pressure, pH-value, and/or viscosity. Agglomeration of the particles may result in non-uniform dispersion of the particles in the additive composition. Hence, a suitable particle size may be also a balance between reducing agglomeration while avoiding blockages in use, all while achieving a uniform dispersion and desired distribution on and/or in the pre-impregnated tape. Furthermore, a form of the particles (nanopowder or suspension) may affect dispersion in the additive composition.

In one example, the additive particles comprise and/or are microparticles, having a diameter in a range from 1 μm to 1000 μm, preferably in a range from 100 μm to 900 μm, more preferably in a range from 150 μm to 850 μm, most preferably in a range from 250 μm to 750 μm, for example 500 μm. In one example, the additive particles comprises and/or are microparticles, wherein at least 50% by weight of the microparticles have a diameter in a range from 10 μm to 1000 μm, preferably in a range from 100 μm to 900 μm, more preferably in a range from 150 μm to 850 μm, most preferably in a range from 250 μm to 750 μm, for example 500 μm. In one example, the additive particles comprises and/or are microparticles, wherein at least 90% by weight of the microparticles have a diameter in a range from 10 μm to 1000 μm, preferably in a range from 100 μm to 900 μm, more preferably in a range from 150 μm to 850 μm, most preferably in a range from 250 μm to 750 μm, for example 500 μm. In one example, the additive particles comprise and/or are microparticles, wherein at least 95% by weight of the microparticles have a diameter in a range from 10 μm to 1000 μm, preferably in a range from 100 μm to 900 μm, more preferably in a range from 150 μm to 850 μm, most preferably in a range from 250 μm to 750 μm, for example 500 μm. In one example, the additive particles comprise and/or are microparticles, wherein at least 99% by weight of the microparticles have a diameter in a range from 10 μm to 1000 μm, preferably in a range from 100 μm to 900 μm, more preferably in a range from 150 μm to 850 μm, most preferably in a range from 250 μm to 750 μm, for example 500 μm.

In one example, the additive particles comprise and/or are nanoparticles and microparticles, as described previously. In one example, the additive particles comprise microparticles in a range from 1% to 99%, preferably in a range from 10% to 90%, more preferably in a range from 25% to 75% by weight of the particles and nanoparticles in a range from 99% to 1%, preferably in a range from 90% to 10%, more preferably in a range from 75% to 25% by weight of the particles, for example balance nanoparticles. In one example, the additive particles consist of nanoparticles and microparticles, as described previously.

It should be understood that the reinforcement fibres provide a substrate for the additive and may be the same as or different from reinforcement particles of the fibre-reinforced composite part. In one example, the reinforcement fibres comprise and/or are electrically insulating reinforcement fibres. In one preferred example, the reinforcement fibres comprise and/or are electrically insulating reinforcement fibres and the additive comprise and/or are electrically conductive particles. In this way, the electrical properties of the pre-impregnated tape may be graded or patterned, for example across a width and/or along a length thereof, to transition between two different fibre-reinforced composite parts having different properties, for example having different dielectric properties, as described previously.

In one example, the reinforcement fibres comprise and/or are electrically conductive reinforcement fibres. In one preferred example, the reinforcement fibres comprise and/or are electrically conductive reinforcement fibres and the additive comprise and/or are electrically insulating particles. In this way, the electrical properties of the pre-impregnated tape may be graduated (e.g. tapered) or patterned, for example across a width and/or along a length thereof, to transition between two different fibre-reinforced composite parts having different properties, for example having different dielectric properties, as described previously.

In one example, the reinforcement fibres comprise non-metal fibres for example glass fibres such as A-glass, E-glass, E-CR-glass, C-glass, D-glass, R-glass, S-glass, S-2-glass and HS-glass; carbon fibres such as aerospace or industrial grades of IM2A, IM2C, IM5, IM6, IM7, IM8, IM9, IM10, AS4, AS4A, AS4C, AS4D, AS7, HM50 and HM63; aramid fibres such as Kevlar®, Nomex® and Technora®; Ultra-High Molecular Weight Polyethylene (UHMwPE) fibres such as Dyneema®; basalt fibres such as Basfiber® or Wiking® Super B; and/or mixtures thereof. In one example, the reinforcement fibres comprise metal and/or alloy fibres for example titanium, aluminium and/or copper and/or alloys thereof; stainless steel fibres; and/or mixtures thereof. In one example, the reinforcement fibres comprise a mixture of non-metal and metal fibres.

In one example, the reinforcement fibres have a diameter in a range from 2 μm to 100 μm, preferably in a range from 4 μm to 50 μm, more preferably in a range from 5 μm to 20 μm, most preferably in a range from 6 μm to 10 μm, for example 6 μm, 7 μm, 8 μm, 9 μm or 10 μm. Typically, suitable carbon fibres have a diameter in a range from 5 μm to 10 μm and suitable glass fibres have a diameter in a range from 4 μm to 20 μm.

In one example, a volume fraction V_{f} of the reinforcement fibres is in a range from 50% to 100%, preferably in a range from 60% to 95%, for example 70%, 80% or 90%, by volume of the pre-impregnated tape. In this way, a relatively high volume fraction V_{f} of the reinforcement fibres in the pre-impregnated tape may be provided.

In one example, a volume fraction V_{f} of the reinforcement fibres is in a range from 30% to 90%, preferably in a range from 40% to 80%, more preferably in a range from 40% to 70%, for example 40%, 45%, 50%, 55%, 60%, 65% or 70% by volume of the fibre-reinforced composite parts. It should be understood that generally, the volume fraction Vₘ of the matrix, for example the first polymeric composition, is related to the volume fraction V_{f} of the reinforcement fibres, for example the first set of reinforcement fibres, by V_{f}+Vₘ=1. In this way, a relatively high volume fraction Ve of the reinforcement fibres in the fibre-reinforced composite parts may be provided.

In one example, the tape comprises aligned and/or continuous reinforcement fibres, for example woven and/or braided continuous fibres. In one example, the reinforcement fibres have a length of at least 2 mm, preferably at least 10 cm, more preferably at least 1 m, most preferably at least 10 m. It should be understood that the length of the reinforcement fibres is a total length of each reinforcement fibre. That is, the reinforcement fibres may comprise and/or are continuous fibres. In one example, impregnating the resin, including the additive, in the tape comprises differentially impregnating the resin, including the additive, in the tape. In this way, the content (i.e. concentration, level, amount, type) of the additive impregnated in and/or on the tape differs at different regions (i.e. parts, areas, volumes, sections) of the tape.

In one example, the method comprises controlling a content of the additive included in the additive composition. In this way, the content (i.e. concentration, level, amount, type) of the additive included in the additive composition is controlled, for example for locally impregnating the resin in the tape at different contents of the additive.

In one example, controlling the content (i.e. concentration, level, amount, type) of the additive included in the additive composition comprises using a masterbatch including the additive. It should be understood that the masterbatch includes the additive at a relatively high content (i.e. concentration, level, amount, type) in the resin, for example a pre-determined content as supplied by a supplier of the masterbatch. In one example, using the masterbatch comprises blending or mixing the masterbatch with further resin (for example, resin not including additive), for example using a static and/or a dynamic blender and/or mixer. Suitable static and/or dynamic blenders and/or mixers are known.

In one example, non-uniformly impregnating the additive composition in and/or on the tape comprises controlling respective flow rates of the masterbatch and/or of the further resin, for example by altering the respective flow rates of the masterbatch and/or of the further resin linearly, nonlinearly, periodically and/or aperiodically across a width and/or along a length of the tape of the tape.

In one example, non-uniformly impregnating the additive composition in and/or on the tape comprises impregnating the additive composition via a set of nozzles, including a first nozzle. In this way, the additive composition may be impregnated locally, according to a position of the set of nozzles, for example the first nozzle, relative to the tape. In this way, by moving the set of nozzles, for example the first nozzle, relative to the tape, a pre-determined pattern of the impregnated additive composition in and/or on the tape may be provided. It should be understood that moving of the set of nozzles, for example the first nozzle, may be computer-controlled, wherein respective nozzles of the set thereof are mutually dependently or independently moved.

In one example, the set of nozzles includes a second nozzle and wherein impregnating the additive composition via the set of nozzles, including the first nozzle and the second nozzle, comprises impregnating a first additive composition, having a first content of the additive, via the first nozzle and impregnating a second additive composition, having a second content of the additive, via the second nozzle, wherein the first content of the additive and the second content of the additive are mutually different. In this way, additive compositions having different contents (i.e. concentration, level, amount, type) of the additive (i.e. the first resin and the second resin) may be impregnated into the tape at respectively different positions simultaneously (i.e. concurrently) and/or successively, for example across a width and/or along a length of the tape. Additionally and/or alternatively, the additive included in the first additive composition and the second additive composition may be different. In one example, the set of nozzles includes N nozzles, wherein N is a natural number greater than or equal to 1, for example 1, 2, 3, 4, 5, 6, 7, 8, 9, 10 or more, for example for impregnating respectively N or <N resins having different contents of the additive simultaneously (i.e. concurrently) and/or successively.

In one example, non-uniformly impregnating the additive composition in and/or on the tape via the set of nozzles, including the first nozzle, comprises moving the first nozzle relative to the tape. In this way, the tape may be patterned using the additive composition. In one example, moving the first nozzle relative to the tape comprises moving the first nozzle transversely, for example orthogonally, to a length of the tape, for example while spooling the pre-impregnated tape, as described below.

In one example, non-uniformly impregnating the additive composition in and/or on the tape comprises wiping the additive composition across and/or along the tape, for example using a wiper. In this way, a distribution of the additive composition is controlled, for example to improve a homogeneity thereof and/or to improve an inhomogeneity thereof, such as to improve non-uniform distribution thereof according to a predetermined pattern.

In one example, the method comprises non-uniformly impregnating the additive composition in and/or on the tape, optionally curing and/or cooling additive composition impregnated in the tape, and spooling the pre-impregnated tape. In this way, a reel-to-reel method of providing the functionalized, pre-impregnated tape is provided, thereby accelerating providing thereof and/or reducing costs while providing the functionalized, pre-impregnated tape in relatively long lengths, for example of at least 1 m, 2 m, 3 m, 4 m, 5 m, 6 m, 7 m, 8 m, 9 m, 10 m, 20 m, 30 m, 40 m, 50 m, 60 m, 70 m, 80 m, 90 m, 100 m, 200 m, 300 m, 400 m, 500 m, 600 m, 700 m, 800 m, 900 m, 1000 m or more.

The method comprises non-uniformly impregnating the additive composition in and/or on the tape. In this way, depositing the additive composition in and/or on the pre-impregnated tape is controlled. In this way, the additive composition is impregnated heterogeneously in and/or on the tape, thereby controlling properties of the functionalised pre-impregnated tape, as described previously. It should be understood that non-uniformly impregnating the additive composition in and/or on the tape provides a non-uniform distribution of the deposited additive across a width and/or along a length of the tape, such that a content (i.e. concentration, level, amount, type) of the deposited additive varies across the width and/or along the length of the pre-impregnated tape, for example according to a pre-determined non-uniform distribution or pattern (i.e. controlled c.f. random), for example varying by a factor of at least 2, 3, 4, 5, 6, 7, 8, 9, 10, 20, 30, 40, 50, 60, 70, 80, 90, 100 or more across the width and/or along the length of the pre-impregnated tape. In contrast, uniformly impregnating the additive composition in and/or on the tape provides a uniform distribution of the deposited additive across a width and/or along a length of the tape, such that a content (i.e. concentration, level, amount, type) of the deposited additive varies across the width and/or along the length of the, for example by a factor of at most 2, 1.75, 1.5, 1.25, 1.1, 1.05 or less across the width and/or along the length of the pre-impregnated tape.

In one example, non-uniformly impregnating the additive composition in and/or on the tape comprises non-uniformly impregnating the additive composition in and/or on the tape across a width and/or a length thereof. In this way, the properties of the pre-impregnated tape may be graduated (e.g. graded or tapered, for example linearly or non-linearly) or patterned (for example periodically or non-periodically), for example across a width and/or along a length thereof, to transition between fibre-reinforced composite parts having different properties, for example having different dielectric properties, as described previously.

In one example, non-uniformly impregnating the additive composition in and/or on the tape comprises depositing the additive in and/or on a periphery (i.e. edges) of the tape, for example for a printed circuit board (PCB).

In one example, non-uniformly impregnating the additive composition in and/or on the tape comprises patterning and/or masking the tape, for example using a pattern and/or a mask. In this way, the additive is deposited corresponding to the pattern and/or the mask. It should be understood that patterning includes masking. Patterning may be controlled, for example programmatically, by controlling flow rate ratios and/or using a mask, while masking uses a mask to obscure regions (i.e. parts, areas, volumes, sections) of the tape, as understood by the skilled person. In one example, masking the tape comprises disposing a mask upstream (i.e. with respect to the impregnating additive composition) of the tape, for example proximal to, confronting or contacting the tape. In this way, fidelity of the correspondence of the deposited additive with respect to the mask is improved.

In one example, non-uniformly impregnating the additive composition in and/or on the tape comprises applying a magnetic field and/or an electric field while impregnating the additive composition in and/or on the tape. In this way, depositing the additive in and/or on the tape is further controlled. In one example, applying the magnetic field and/or the electric field while impregnating the additive composition in and/or on the tape comprises applying the magnetic field and/or the electric field parallel with or transversely to the impregnating resin.

In one example, non-uniformly impregnating the additive composition in and/or on the tape comprises depositing the additive on the reinforcement fibres and/or in pores therebetween.

In one example, the method comprises reacting the additive. In this way, the additive is deposited in and/or on the pre-impregnated tape and subsequently reacted. In one example, the method comprises functionalizing the additive. In this way, non-particles are deposited in and/or on the pre-impregnated tape and subsequently functionalized. For example, metal oxide particles may be reduced to metal particles.

In one example, the method comprises dispersing and/or suspending the particles in the additive composition, for example in the resin, as described previously.

In one example, non-uniformly impregnating the additive composition in and/or on the tape comprises injecting, jetting or pumping the additive composition into the tape, for example using a pump. Methods of impregnating tapes with resin are known.

In one example, non-uniformly impregnating the additive composition in and/or on the tape comprises orienting the tape relative to the impregnating additive composition, for example at an angle thereto. In this way, a non-uniform distribution of the deposited additive across a width and/or along a length of the tape is provided.

In one example, the resin comprises a first polymeric composition, as described below.

In one example, the reinforcement fibres are surrounded, at least in part, with a first polymeric composition, for example when the tape is a pre-preg. In this way, handling of the pre-impregnated tape is improved. In one example, the tape is a pre-impregnated tape. In one example, the tape is dry i.e. not surrounded, at least in part, with the first polymeric composition.

Generally, pre-preg is “pre-impregnated” reinforcement fibres where a thermoset polymer matrix material, such as an epoxy, or a thermoplastic resin matrix is already present. The fibres may take the form of a weave and the matrix is used to bond the fibres together and to other components during manufacture. The thermoset matrix is only partially cured to allow easy handling; this B-Stage material requires cold storage to prevent complete curing. B-Stage pre-preg is always stored in cooled areas since heat accelerates complete polymerization. Thermoplastic matrices do not require such cold-storage. Hence, composite structures built of pre-pregs will mostly require an oven or autoclave to cure. Pre-preg allows impregnation of the fibres on a flat surface, for example, and then later, laying of the impregnated fibres to provide a desired shape, which could be otherwise problematic to lay without the matrix.

Thermoplastic prepregs may be provided in unidirectional tape, or in fabrics that are woven or stitched, for example.

In one example, the first polymeric composition comprises a first thermoplastic, selected from a group comprising acrylonitrile butadiene styrene (ABS), polylactic acid (PLA), polycarbonate (PC), polyamide (PA), polystyrene (PS), high-density polyethylene (HDPE), PC/ABS, polyethylene terephthalate (PETG), polyphenylsulfone (PPSU), high impact polystyrene (HIPS), polytetrafluoroethylene (PTFE), lignin, rubber, and/or a polyaryletherketone (PAEK), such as polyetherketoneketone (PEKK), polyetheretherketone (PEEK) and polyetherimide (PEI). In one example, the first thermoplastic comprises, consists of and/or is PEKK, PEEK and/or PEI, preferably PEKK and/or PEEK, more preferably PEKK. Compared with PEEK, a PEKK is more robust (i.e. less sensitive) to cooling rate, due, at least in part, to a wider range of acceptable crystallinity.

In one example, the first polymeric composition comprises a reactive thermoplastic resin, such as Elium®. Elium is a liquid monomer that may be processed like a thermoset but upon reaction, transforms into a thermoplastic which may be subsequently thermoformed, melted and/or welded. Anionic polymerization of caprolactam (a monomer of polyamide-6, PA-6) is also suitable. Generally, reactive thermoplastic resins may be cured after laying, for example by heating and/or using a catalyst included in the first polymeric composition, thereby reacting molecules thereof to provide a thermoplastic having improved mechanical properties.

In one example, the first polymeric composition comprises a second thermoplastic, as described above with respect to the first thermoplastic (i.e. a copolymer).

In one example, the first polymeric composition comprises a thermoset, for example an epoxy, benzoxazine, bis-maleimides (BMI), polyimide, polyurethane, silicone, vinyl, amino, furan, phenolic and/or cyanate ester resin, and optionally a hardener.

Selection of an appropriate first polymeric composition for the reinforcement fibres is known.

In one example, the method comprises dispersing, redispersing and/or agitating the additive included in the additive composition, for example continuously, for example while impregnating the additive composition in and/or on the pre-impregnated tape, for example ultrasonically, by stirring, using a mixer, to maintain a dispersion, for example a homogeneous dispersion, of the additive in the resin.

In one example, the method comprises altering (i.e. changing, more generally controlling) in-line and/or in realtime, a content of the additive included in the additive composition. In this way, bespoke pre-impregnated tape, for example reels thereof, may be provided.

A second aspect provides an apparatus for providing a pre-impregnated tape, comprising reinforcement fibres, for manufacture of fibre-reinforced composite parts, the apparatus comprising: non-uniformly impregnating an additive composition in and/or on a tape to provide the pre-impregnated tape, wherein the additive composition comprises a resin and an additive and wherein the tape comprises reinforcement fibres.

The pre-impregnated tape, the reinforcement fibres, the fibre-reinforced composite parts, the depositing, the additive and/or the resin may be as described with respect to the first aspect.

In one example, the apparatus comprises a set of nozzles, including a first nozzle, as described with respect to the first aspect.

In one example, the apparatus comprises means to disperse (such as nozzles for liquids/gasses, hoppers and/or agitators, electrostatically/-magnetically charged or otherwise, for example resonant acoustic mixing) the additive in the resin.

A third aspect provides a pre-impregnated tape, comprising reinforcement fibres, having non-uniformly deposited additive therein and/or thereon, for example provided according to the method of the first aspect and/or using the apparatus according to the second aspect.

The pre-impregnated tape, the reinforcement fibres, the fibre-reinforced composite parts, the depositing and/or the additive may be as described with respect to the first aspect.

A fourth aspect provides a method of manufacturing a fibre-reinforced composite part, for example an aircraft composite part, such as an airframe or part thereof, the method comprising:
providing a first fibre-reinforced composite part and providing a second fibre-reinforced composite part, wherein the first fibre-reinforced composite part and the second fibre-reinforced composite part have different properties, such as electrical, thermal, magnetic and/or structural properties;
joining the first fibre-reinforced composite part and the second fibre-reinforced composite part; and
transitioning between the first fibre-reinforced composite part and the second fibre-reinforced composite part using a pre-impregnated tape, for example provided according to the method of the first aspect and/or using the apparatus according to the second aspect and/or according to the third aspect.

Providing the first fibre-reinforced composite part and providing the second fibre-reinforced composite part are known. Joining the first fibre-reinforced composite part and the second fibre-reinforced composite part is generally known.

In one example, joining the first fibre-reinforced composite part and the second fibre-reinforced composite part comprises joining the first fibre-reinforced composite part and the second fibre-reinforced composite part using, at least in part, the pre-impregnated tape.

A fifth aspect provides a fibre-reinforced composite part, for example an aircraft composite part, such as an airframe or part thereof, comprising a pre-impregnated tape according to the third aspect and/or manufactured according to the fourth aspect.

### BRIEF DESCRIPTION OF THE FIGURES

Embodiments of the invention will now be described by way of example only with reference to the figures, in which:

FIG. 1(a) schematically depicts a method according to an exemplary embodiment; and

FIG. 1(b) shows the method, in more detail; and

FIGS. 2(a) to 2(d) schematically depict additive particle contents of pre-impregnated tapes according to exemplary embodiments.

### DETAILED DESCRIPTION

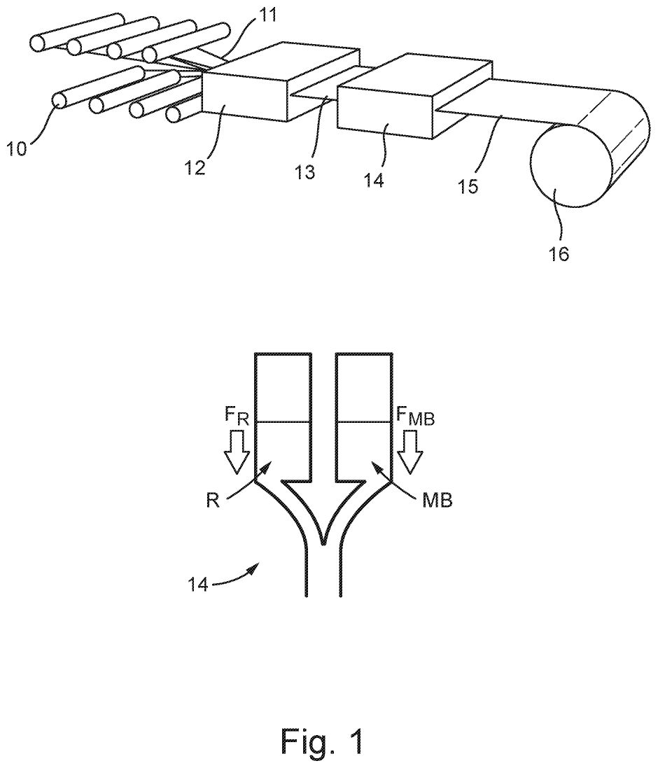

FIG. 1(a) schematically depicts a method according to an exemplary embodiment.

The method is of providing a pre-impregnated tape 15 for manufacture of fibre-reinforced composite parts, the method comprising:
non-uniformly impregnating 14 an additive composition in and/or on a tape 13, comprising reinforcement fibres 11, to provide the pre-impregnated tape 15, wherein the additive composition comprises a resin and an additive.

In more detail, the invention alters the concentration of an additive, functional or otherwise, that is incorporated into impregnate resin, using a differential impregnation unit 14. The invention allows a roll of pre-impregnated tape to be manufactured with a gradient of additives across both the width and length of spooled prepreg material with consideration to the ratio of resin to functional masterbatch as seen in FIG. 1(b).

Spooled tows of the reinforcement fibres 11 on spools 10 are processed through a spreading unit 12 as typical to standard prepregging techniques, however the concentration of additive or functional fillers is altered by changing the ratio of flow rates F_{R} and F_{MB}, of neat resin R to an additive or functional master batch resin MB, respectively.

In more detail, FIG. 1(b) shows details of the differential impregnation unit 14. A concentration of functional masterbatch MB, and therefore conductivity, for example, is controlled through altering the flow rate ratios F_{R} and F_{MB} of resin R to masterbatch MB, allowing dynamic control over functionality across spooled material. In this example, the pre-impregnated tape 15 is spooled on a spool 16.

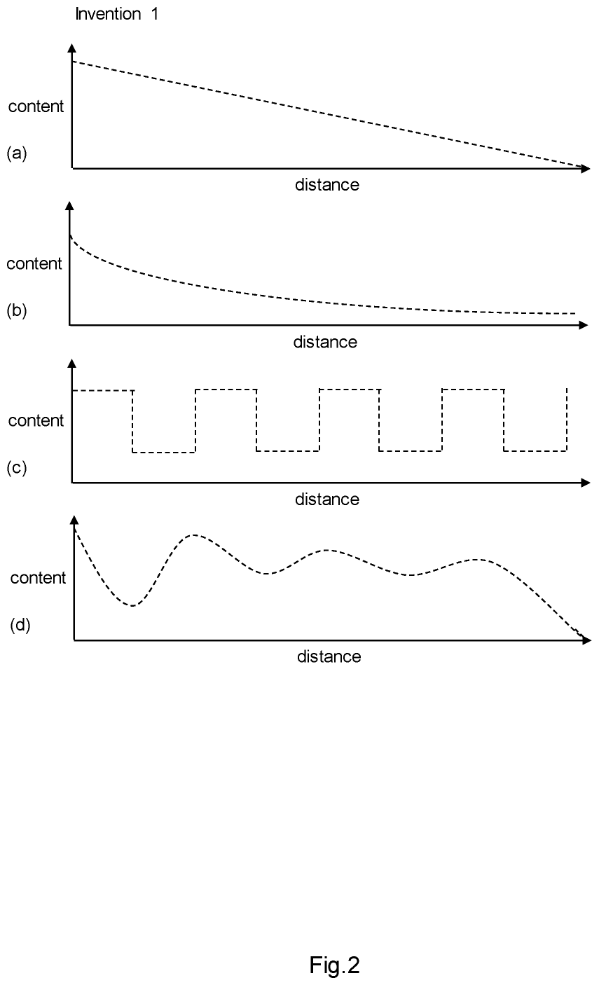

FIGS. 2(a) to 2(d) schematically depict additive particle contents of tapes according to exemplary embodiments.

FIG. 2(a) schematically depicts additive particle content of a pre-impregnated tape decreasing linearly across a width of the pre-impregnated tape 15. In this example, the flow rate ratios F_{R} and F_{MB} are altered linearly across the width of the tape 13 by the differential impregnation unit 14. In this example, non-uniformly impregnating the additive composition in and/or on the tape comprises controlling respective flow rates of the masterbatch and/or of the further resin, by altering the respective flow rate ratios F_{R} and F_{MB} linearly across the width of the tape 13.

FIG. 2(b) schematically depicts additive particle content of a pre-impregnated tape decreasing non-linearly across a width of the pre-impregnated tape. In this example, the flow rate ratios F_{R} and F_{MB} are altered non-linearly across the width of the tape 13 by the differential impregnation unit 14. In this example, non-uniformly impregnating the additive composition in and/or on the tape comprises controlling respective flow rates of the masterbatch and/or of the further resin, by altering the respective flow rate ratios F_{R} and F_{MB} non-linearly across the width of the tape 13.

FIG. 2(c) schematically depicts additive particle content of a pre-impregnated tape varying periodically across a width of the pre-impregnated tape. In this example, the flow rate ratios F_{R} and F_{MB} are altered periodically across the width of the tape 13 by the differential impregnation unit 14. In this example, non-uniformly impregnating the additive composition in and/or on the tape comprises controlling respective flow rates of the masterbatch and/or of the further resin, by altering the respective flow rate ratios F_{R} and F_{MB} periodically across the width of the tape 13.

FIG. 2(d) schematically depicts additive particle content of a pre-impregnated tape varying aperiodically across a width of the pre-impregnated tape. In this example, the flow rate ratios F_{R} and F_{MB} are altered aperiodically across the width of the tape 13 by the differential impregnation unit 14. In this example, non-uniformly impregnating the additive composition in and/or on the tape comprises controlling respective flow rates of the masterbatch and/or of the further resin, by altering the respective flow rate ratios F_{R} and F_{MB} aperiodically across the width of the tape 13.

What is claimed is:

1. A method of providing a pre-impregnated tape suitable for manufacture of fibre-reinforced composite parts, the method comprising:
non-uniformly impregnating an additive composition in and/or on a tape to provide the pre-impregnated tape;
wherein the additive composition comprises a resin and an additive; and
wherein the tape comprises reinforcement fibres.

2. The method according to claim 1, wherein the additive is electrically conductive particles.

3. The method according to claim 1, wherein the reinforcement fibres are electrically insulating reinforcement fibres.

4. The method according to claim 1, wherein the tape comprises reinforcement fibres comprise aligned and/or continuous reinforcement fibres.

5. The method according to claim 1, wherein non-uniformly impregnating the additive composition in and/or on the tape comprises differentially impregnating the additive composition in and/or on the tape.

6. The method according to claim 1, wherein non-uniformly impregnating the additive composition in and/or on the tape comprises non-uniformly impregnating the additive composition in and/or on the tape across a width and/or along a length thereof.

7. The method according to claim 1, wherein the method comprises spreading one or more tows, comprising the reinforcement fibres, thereby providing the tape.

8. The method according to claim 1, further comprising controlling a content of the additive included in the additive composition using a masterbatch including the additive and/or a further resin.

9. The method according to claim 8, wherein controlling the content of the additive included in the additive composition comprises controlling respective flow rates of the masterbatch and/or of the further resin by altering the respective flow rates of the masterbatch and/or of the further resin linearly, nonlinearly, periodically and/or aperiodically across a width and/or along a length of the tape.

10. The method according to claim 1, wherein non-uniformly impregnating the additive composition in and/or on the tape comprises impregnating the additive composition via a set of nozzles, including a first nozzle.

11. The method according to claim 10, wherein the set of nozzles includes a second nozzle and wherein impregnating the additive composition via the set of nozzles, including the first nozzle and the second nozzle, comprises impregnating a first additive composition, having a first content of the additive, via the first nozzle and impregnating a second additive composition, having a second content of the additive, via the second nozzle, wherein the first content of the additive and the second content of the additive are mutually different.

12. The method according to claim 10, wherein impregnating the additive composition, including the additive, via the set of nozzles, including the first nozzle, comprises moving the first nozzle relative to the tape.

13. The method according to claim 1, further comprising spooling the pre-impregnated tape.

14. The method according to claim 1, further comprising reacting and/or functionalizing the additive.

15. An apparatus for providing a pre-impregnated tape suitable for manufacture of fibre-reinforced composite parts, the apparatus comprising:
an impregnating mechanism configured for non-uniformly impregnating an additive composition in and/or on a tape, comprising reinforcement fibres, to provide the pre-impregnated tape;
wherein the additive composition comprises a resin and an additive.
